(19) United States
(12) Patent Application Publication
(10) Pub. No.: US 2011/0175997 A1
(43) Pub. Date: Jul. 21, 2011

(54) HIGH SPEED OPTICAL INSPECTION SYSTEM WITH MULTIPLE ILLUMINATION IMAGERY

(75) Inventors: Steven K. Case, St. Louis Park, MN (US); Caruso Beverly, St. Louis Park, MN (US); Chuanqi Chen, Maple Grove, MN (US); Carl Haugan, St. Paul, MN (US)

(73) Assignee: Cyberoptics Corporation, Golden Valley, MN (US)

(21) Appl. No.: 12/864,110

(22) PCT Filed: Jan. 23, 2009
(86) PCT No.: PCT/US09/31744

§ 371 Date: Jan. 21, 2011

Related U.S. Application Data
(60) Provisional application No. 61/022,974, filed on Jan. 23, 2008.

(51) Int. Cl. H04N 7/18

(52) U.S. Cl. 348/92

(57) ABSTRACT

An optical inspection system (92) for inspecting a workpiece (10) including a feature (60) to be inspected is provided. The system (92) includes a workpiece transport conveyor (26) configured to transport the workpiece (10) in a nonstop manner. The system (92) also includes an illuminator (9) configured to provide a first strobed illumination field type and a second strobed illumination field type. An array of cameras (4) is configured to digitally image the feature, wherein the array of cameras (4) is configured to generate a first image of the feature with the first illumination field and a second image of the feature with the second illumination field. A processing device (90) is operably coupled to the illuminator (9) and the array of cameras (4), the processing device (90) provides an inspection result relative to the feature (60) on the workpiece (10) based, at least in part, upon the first and second images.

### BACKGROUND

Automated electronics assembly machines are often used in the manufacture of printed circuit boards, which are used in various electronic devices. Such automatic electronic assembly machines are often used to process other devices that are similar to printed circuit boards. For example, the manufacture of photovoltaic cells (solar cells) often uses similar machines for printing conductive traces. Regardless of the substrate being processed, the process itself is generally required to operate quite swiftly. Rapid or high speed manufacturing ensures that costs of the completed substrate are minimized. However, the speed with which the substrates are manufactured must be balanced by the acceptable level of scrap or defects caused by the process. Printed circuit boards, for example, can be extremely complicated and small and any one board may have a vast number of components and consequently a vast number of electrical connections. Printed circuit boards are now produced in large quantities. Since such printed circuit boards can be quite expensive and/or be used in expensive equipment, it is important that they be produced accurately and with high quality, high reliability, and minimum scrap. Unfortunately, because of the manufacturing methods available, some level of scrap and rejects still occurs. Typical faults on printed circuit boards include inaccuracy of placement of components on the board, which might mean that the components are not correctly electrically connected in the board. An incorrect component may be placed at a given location on a circuit board, the component might be absent, or the component may be placed with incorrect electrical polarity. Further, other errors may prohibit, or otherwise inhibit electrical connections between one or more components, and the board. Further still, if there is insufficient solder paste deposits, this can lead to poor connections. Additionally, if there is too much solder paste, such a condition can lead to short circuits, and so on.

In view of all of these industry demands, a need has arisen for automated optical inspection systems. These systems can receive a substrate, such as a printed circuit board, either immediately after placement of the components upon the printed circuit board and before wave soldering, or post reflow. Typically, the systems include a conveyor that is adapted to move the substrate under test through an optical field of view that acquires one or more images and analyzes those images to automatically draw conclusions about components on the substrate and/or the substrate itself. One example of such device is sold under the trade designation Flex Ultra™ HR available from CyberOptics Corporation, of Golden Valley, Minn. However, as described above, the industry continues to pursue faster and faster processing, and accordingly faster automated optical inspection is desired. Moreover, given the wide array of various objects that the system may be required to inspect, it would be beneficial to provide an automated optical inspection system that was not only faster than systems of the prior art, but better able to provide valuable inspection data relative to a wider variety of components, substrates, or inspection criteria.

### SUMMARY

An optical inspection system for inspecting a workpiece including a feature to be inspected is provided. The system includes a workpiece transport conveyor configured to transport the workpiece in a nonstop manner. The system also includes an illuminator configured to provide a first strobed illumination field type and a second strobed illumination field type. An array of cameras is configured to digitally image the feature, wherein the array of cameras is configured to generate a first image of the feature with the first illumination field and a second image of the feature with the second illumination field. A processing device is operably coupled to the illuminator and the array of cameras, the processing device provides an inspection result relative to the feature on the workpiece based, at least in part, upon the first and second images.

### BRIEF DESCRIPTION OF THE DRAWINGS

FIG. 1 is a diagrammatic view of an automated high speed optical inspection system having multiple illumination imagery in accordance with embodiment of the present invention.

FIG. 2 is a diagrammatic elevation view of a plurality of cameras having overlapping fields of view in accordance with the embodiment of the present invention.

FIGS. 3A and 3B are perspective and top plan views of a component soldered upon a printed circuit board.

FIG. 4 is a portion of an elevation view illustrating brightfield illumination in accordance with an embodiment of the present invention.

FIG. 5 is a portion of an elevation view illustrating darkfield illumination in accordance with an embodiment of the present invention.

FIG. 6 is a block diagram of an inspection system in accordance with an embodiment of the present invention.

FIG. 7 is a diagrammatic perspective view of an inspection system in accordance with an embodiment of the present invention.

FIG. 8 is a top plan view of an inspection system in accordance with an embodiment to the present invention showing overlapped fields of view of a camera array.

FIG. 9 is a top plan view of an inspection system in accordance with an embodiment of the present invention showing overlapped fields of view of a camera array.

FIG. 10 is a top plan view of an inspection system in accordance with an embodiment of the present invention.

FIGS. 11A through 11D are top plan views illustrating varying column images used for inspection in accordance with an embodiment of the present invention.

FIG. 12 is a flow diagram of a method of acquiring images for automated optical inspection in accordance with an embodiment of the present invention.

FIG. 13 is a flow diagram of a method of inspecting a substrate in accordance with an embodiment of the present invention.

### DETAILED DESCRIPTION OF ILLUSTRATIVE EMBODIMENTS

Embodiments of the present invention generally provide an inspection system with high speed, multiple illumination images, without the need for expensive and sophisticated motion control hardware. Joint processing of the images acquired with different illumination patterns may appreciably enhance the inspection results.

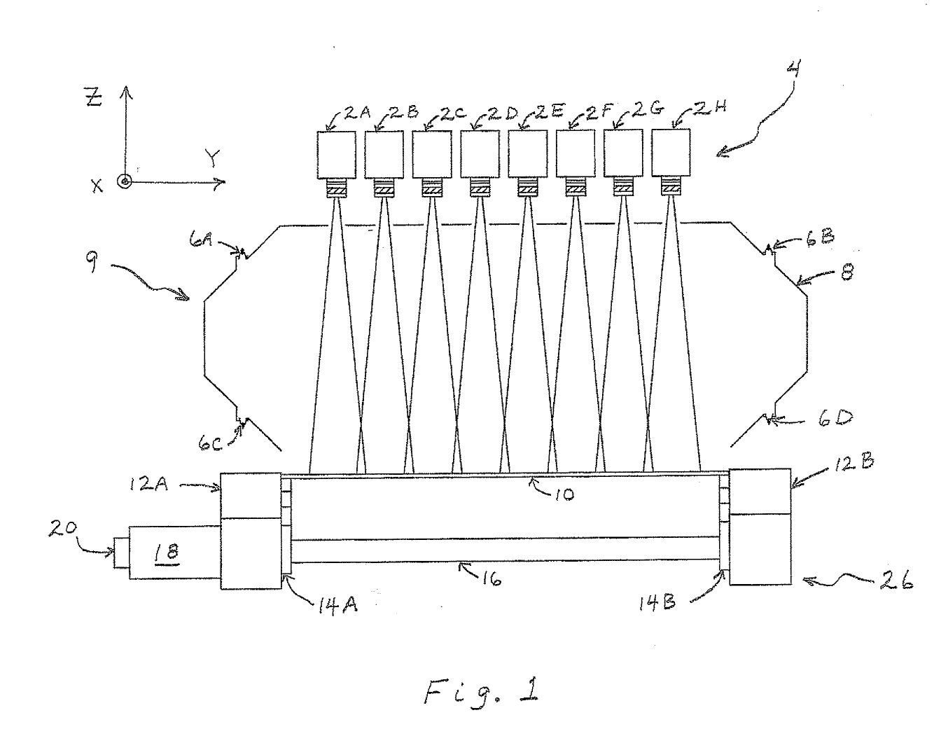

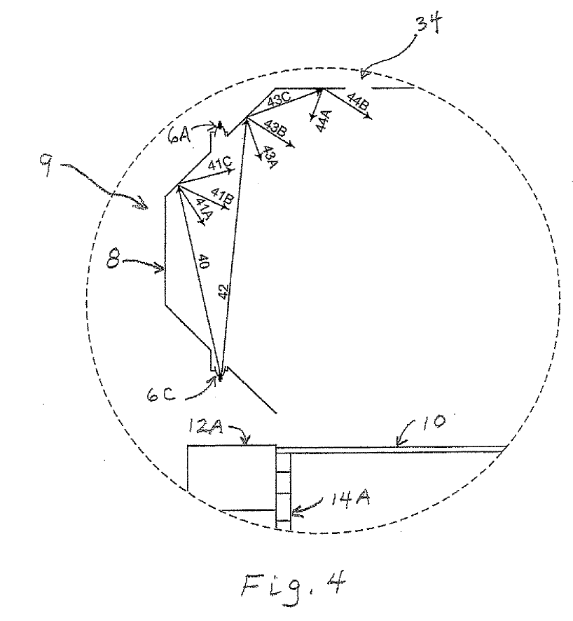

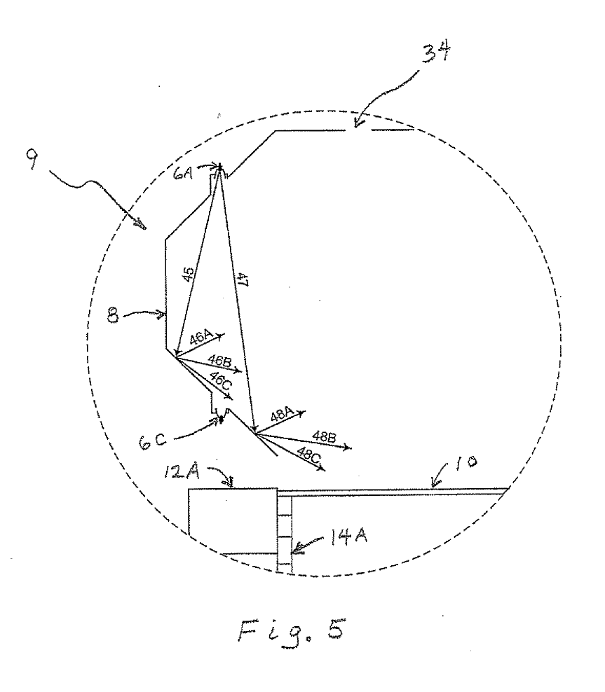

FIG. 1 shows an elevation view of a system for generating high contrast, high speed digital images of a workpiece that are suitable for automated inspection, in accordance with an embodiment of the present invention. Camera array 4 consists of cameras 2A through 2H arranged at regular intervals. Each camera 2A through 2H simultaneously images and digitizes a rectangular area on a workpiece or substrate, such as printed circuit board 10. Illuminator 9 provides a series of pulsed, short duration illumination fields referred to as strobed illumination. The short duration of each illumination field, or pattern, effectively “freezes” the image of printed circuit board 10 to suppress motion blurring. Two or more sets of images for each location on printed circuit board 10 are generated by camera array 4 with different illumination patterns for each exposure. Depending on the particular features on printed circuit 10 board that need to be inspected, the inspection results may be appreciably enhanced by joint processing of the reflectance images generated by different illumination patterns. Further details of illuminator 9 are provided in the description of FIG. 4 and FIG. 5.

Workpiece transport conveyor 26 translates printed circuit board 10 in the X direction in a nonstop mode to affect the high speed imaging of printed circuit board 10 by camera array 4. Conveyor 26 includes support rails 12A and 12B and belts 14A and 14B which are driven by motor 18 and shaft 16. Optional encoder 20 measures the position of shaft 16 and hence the approximate distance traveled by printed circuit board 10. Other methods of measuring and encoding the distance traveled of printed circuit board 10 include time-based, acoustic or vision-based encoding methods. By using strobed illumination and not bringing printed circuit board 10 to a stop, the time-consuming transport steps of accelerating, decelerating, and settling prior to imaging by camera array 4 are eliminated. It is believed that the time required to entirely image a printed circuit board 10 of dimensions 210 mm×310 mm can be reduced from 11 seconds to 4 seconds using the present invention compared to coming to a complete stop before imaging.

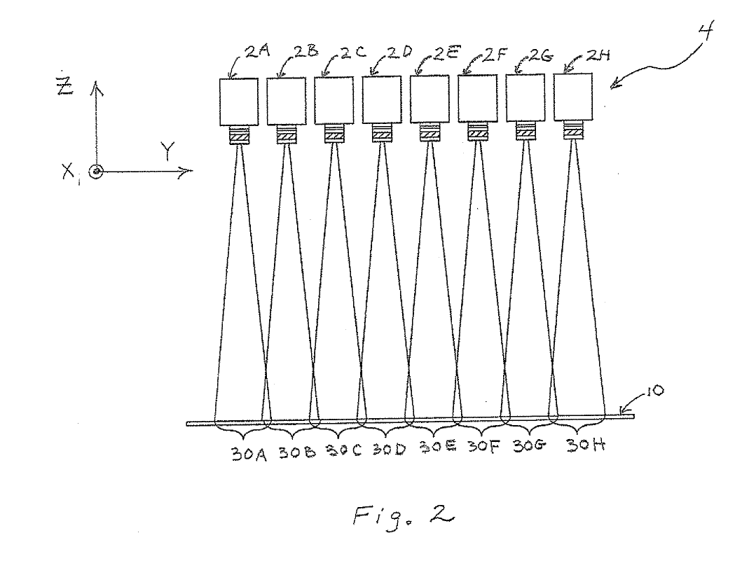

FIG. 2 shows the Y dimension location of each field of view 30A through 30H on printed circuit board 10 that is imaged by cameras 2A through 2H, respectively. There is a slight overlap between adjacent fields of view in order to completely image all locations on printed circuit board 10. In practice, circuit boards will not be planar, but rather will have a slight amount of warp or bow. It is also apparent from FIG. 1 that printed circuit board 10 is supported only along its edges by belts 14A and 14B. So, for example, if printed circuit board 10 has a slight amount of warp in the negative Z direction, then dimensions of fields of view 30A through 30H will increase slightly and the overlap regions will also decrease slightly. During the inspection process, the images of discrete fields of view 30A through 30H are digitally merged, or stitched, into one continuous image in the overlap regions. Example camera array 4 is shown in FIGS. 1 and 2 arranged as a single dimensional array of discrete cameras. In another embodiment, the camera array may be arranged in a two dimensional array. For example, the discrete cameras may be arranged into a camera array of two columns of four cameras where adjacent fields of view overlap. Other arrangements of the camera array may be advantageous depending on cost, speed, and performance goals of the inspection system.

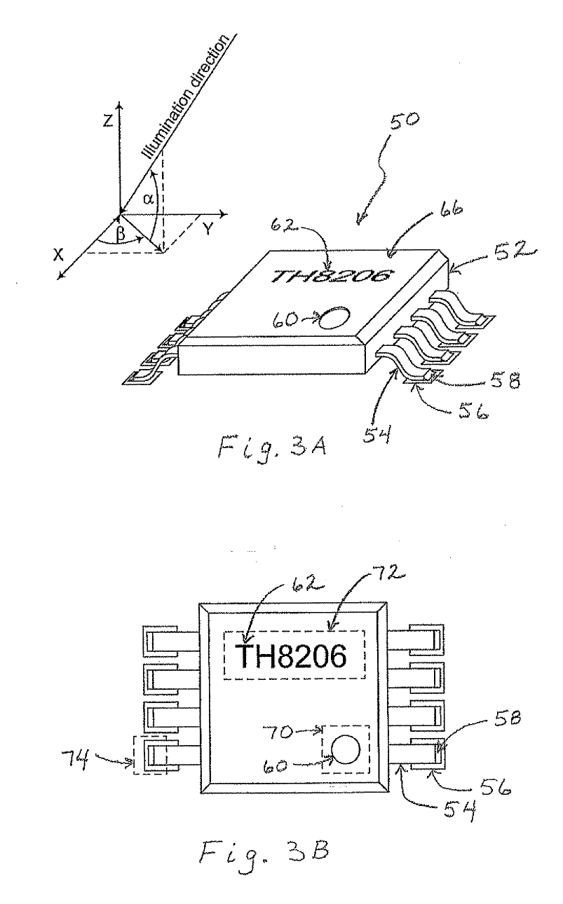

FIGS. 3A and 3B show a typical electrical component 50 that is placed and soldered onto printed circuit board 10. Component 50 includes a plurality of leads 54, contact pads 56, and solder fillets 58. Solder fillets 58 make electrical contact between leads 54 and pads 56 and also mechanically secure leads 54 to pads 56. Polarity mark 60 is shown as a circular impression on top surface 66 of package body 52. Text 62 typically identifies the component type and optional information such as the manufacturer and date code.

FIG. 3A shows a coordinate reference frame and defines the angles for light projected onto printed circuit board 10 and example component 50. It is understood by those skilled in the art that the image contrast of the various features on component 50 will vary depending on several factors including the feature geometry, color, reflectance properties, and the angular spectrum of illumination incident on each feature. The brief discussion that follows is meant for illustrative purposes to explain how image contrast may be affected by illumination direction or the angular spectrum of illumination. For example, consider the case where the angular spectrum of the illumination incident on polarity mark 60 is primarily from a vertical direction with altitude angles α approaching 90° and is uniformly distributed in azimuth angle 0°<β<360°. Illumination with this angular spectrum is commonly referred to as brightfield illumination. If the material in the circular impression 60 is the same as the top surface 66, then the image contrast will be low. Next, consider the case where the angular spectrum of the illumination incident on polarity mark 60 is primarily from a more horizontal direction with smaller altitude angles 0°<α<45° and is uniformly distributed in azimuth angle 0°<β<360°. Illumination with this angular spectrum is commonly referred to as darkfield illumination. The edge of circular impression 60 will then scatter a fraction of this light into the vertical Z direction which will result in a higher contrast image of the edge. Conversely, darkfield illumination might produce a low contrast image of printed text 62, whereas a higher contrast image might be produced with brightfield illumination. For ease of description, the terms brightfield and darkfield illumination are used to illustrate contrast in angles of incidence. However, those terms are not meant to limit embodiments of the present invention, and those skilled in the art will recognize that embodiments of the present invention can be practiced with any two illumination types as long as the types differ in some important respect, such as angle of incidence.

The image contrast of each feature of component 50 as well as all other features of interest on printed circuit board 10 may be enhanced by combining a linear combination of both brightfield and darkfield illumination as opposed to using a single illumination type. The ratios of brightfield and darkfield illumination that must be combined to provide high contrast are dependent on the features. Since each field of view 30A through 30H may contain a wide variety of features with different illumination requirements, embodiments of the present invention address this challenge by imaging each feature and location on printed circuit board 10 two or more times, with each of these images captured under different illumination conditions and then stored into a digital memory. In general, the inspection performance may be improved by joint processing of the images of each feature. For example, the joint processing of feature shapes in each image may uniquely identify the defect type. The specific joint processing technique used may be dependant on the feature to be inspected.

FIG. 4 is a section view of illuminator 9. Illuminator 9 includes illuminator enclosure 8 which houses light sources 6A and 6C, as well as light sources 6B and 6D as shown in FIG. 1. Light sources 6A-6D are preferably xenon arc discharge lamps with reflectors for improving light collection efficiency. Xenon arc discharge lamps may provide between 1 to 2 joules of optical energy within a 40 microsecond pulse to properly expose cameras 2A-2H and suppress effects of blurring due to printed circuit board 10 traveling in a nonstop manner. Illuminator 9 also includes a plurality of apertures 34 that provide cameras 2A through 2H with an unobstructed view of printed circuit board 10. The interior of enclosure 8 is preferably constructed of highly reflective material that scatters light in multiple directions. Two example light rays 40, 42 which are generated by light source 6C are shown in FIG. 4. Ray 42 strikes the interior of illuminator enclosure 8 where it is scattered and generates secondary reflection light rays 43A, 4313, and 43C. Ray 43C strikes the interior of enclosure 8 where it generates additional reflection rays shown as 44A and 44B. Example light ray 40 strikes the interior of illumination enclosure 8 and generates secondary reflections light rays shown as 41A, 41B, and 41C. A similar set of scattered light rays are generated by light source 6D. A brightfield illumination pattern is generated when light sources 6C and 6D are simultaneously energized since the scattered light incident on printed circuit board 10 originates from locations within enclosure 8 that are mainly vertical to relative to printed circuit board 10.

Light rays generated by light sources 6C and 6D undergo multiple scatterings before they illuminate printed circuit board 10. These multiple scatterings greatly reduce peaks, spikes, or “hot spots” in the illumination angular spectrum and have the effect of generating a smoothly varying angular spectrum. Reducing peaks in the angular spectrum is important in order to avoid anomalous bright reflections within each image.

FIG. 5 is the same section view of illuminator 9 as shown in FIG. 4 but with example light rays 45, 47 generated by light source 6A. Example light ray 45 strikes the interior of illuminator enclosure 8 where it is scattered and generates secondary reflection light rays 46A, 46B, and 46C. Example light ray 47 strikes the interior of illumination enclosure 8 and generates additional reflections light rays shown as 48A, 48B, and 48C. A similar set of scattered light rays are generated by light source 6B. A darkfield illumination pattern is projected onto printed circuit board 10 when light sources 6A and 613 are simultaneously energized since the scattered light incident on printed circuit board 10 originates from locations within enclosure 8 that are mainly horizontal relative to printed circuit board 10.

It should be understood that embodiments of the present invention are not limited to two lighting types such as darkfield and brightfield illumination patterns nor are they limited to the specific illuminator configuration discussed with reference to FIGS. 4 and 5. The light sources may project directly onto workpiece 10. The light sources may also have different wavelengths, or colors, and be located at different angles with respect to workpiece 10. The light sources may be positioned at various azimuthal angles around workpiece 10 to provide illumination from different quadrants. The light sources may be a multitude of high power LEDs that emit light pulses with enough energy to “freeze” the motion of workpiece 10 and suppress motion blurring in the images. Numerous other lighting configurations are within the scope of the invention including light sources that transmit through the substrate of workpiece 10 to backlight features to be inspected.

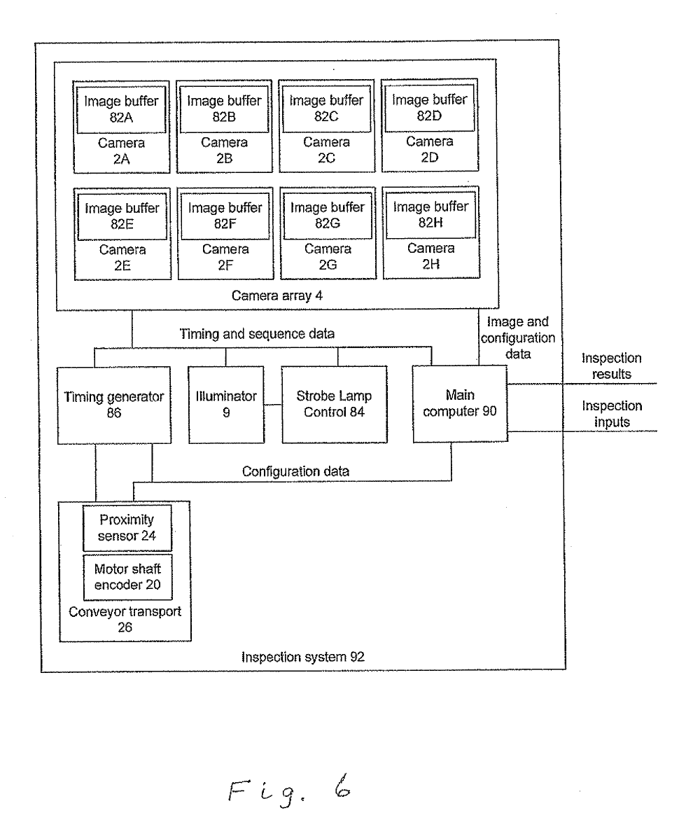

A block diagram of inspection system 92 will now be described with respect to FIG. 6. Inspection inputs are programmed into main computer 90. Typical inputs include the type of printed circuit board 10, CAD information describing the location and types of components on printed circuit board 10, the features on printed circuit board 10 to be inspected, a linear combination of image intensity values to be used for each inspected feature, lighting and camera calibration data, the conveyor transport 26 direction, etc. Computer 90 configures conveyor 26 with the transport direction and velocity. Computer 90 also configures timing generator with the number of motor shaft encoder 20 counts to hold off at the beginning of the image acquisition sequence as well as the number of encoder 20 counts between each subsequent image acquisition of camera array 4. Computer 90 also programs appropriate parameters into cameras 2A-2H prior to an inspection.

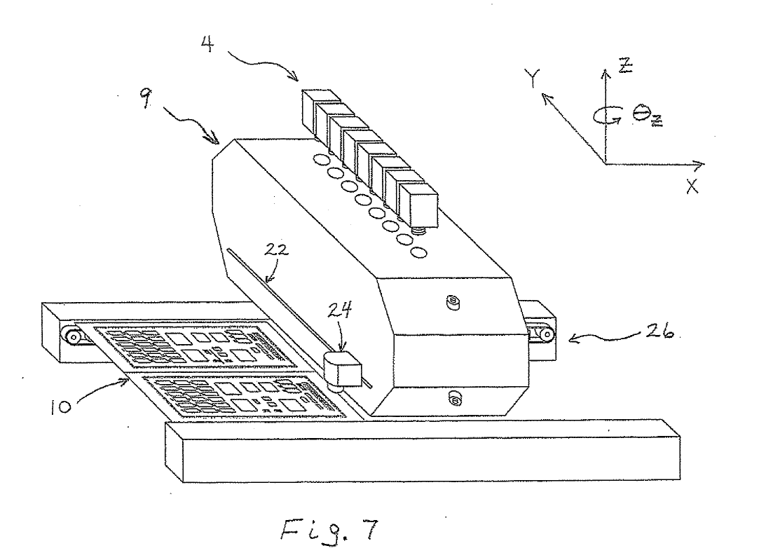

Proximity sensor 24, shown in FIG. 7, senses the edge of printed circuit board 10 as it is loaded into inspection system 92 and this signal is sent to timing generator 86 to begin an inspection sequence. Timing generator 86 generates the appropriate signals to begin each image exposure by camera array 4 and command strobe lamp control 84 to energize the appropriate light sources at the proper time. Each camera 2A-2H preferably contains an image buffer 82A-82H that contains enough memory to store all images generated for one inspection cycle. Since the image buffer is located within each camera the contents of the image data may be transferred at high speed into the image buffer to allow each camera to be quickly prepared for subsequent exposures. This allows the printed circuit board 10 to be transported through inspection system 92 in a nonstop manner and image each location on printed circuit board 10 under at least two different illumination pattern conditions. The image data may begin to be read out of image buffers 82A-82H as soon as the first images are transferred to buffers 82A-82H. In another embodiment, the electronics and packaging of discrete cameras 2A-2H are combined in an integrated camera array 4 to eliminate redundant power supplies, logic devices, connectors, and housings. In this embodiment, individual image buffers 82A-82H may be combined into single image buffer. It is believed that integrated camera arrays 4 having four, six, or eight image detectors and a single buffer memory with capacity to store all acquired images of a single printed circuit board 10 are advantageous.

FIG. 7 is a perspective view of printed circuit board 10 position just prior to the start of the image acquisition process. Optical proximity sensor 24 generates a signal to timing generator 86 as the leading edge of printed circuit board 10 travels over it. Timing generator 86 then either counts a predetermined number of encoder 20 counts or delays a predetermined time before sending a signal to camera array 4 and strobe lamp control 84 to begin the image acquisition sequence. Position of proximity sensor 24 may be adjusted in the Y direction using slot 22 to accommodate irregularly shaped circuit boards 10 or circuit boards 10 that have cutout areas along the leading edge.

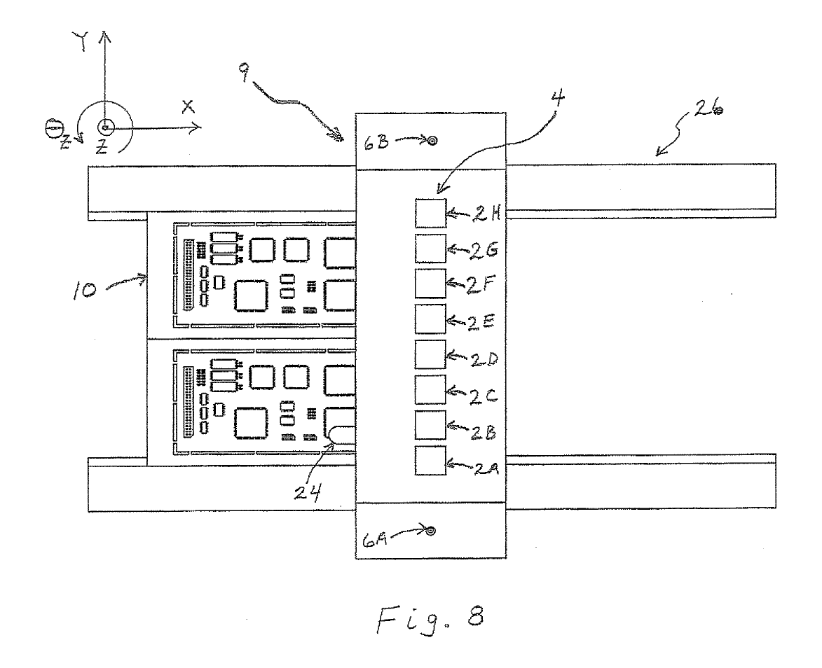

The image acquisition process will now be described in further detail with respect to FIG. 8. FIG. 8 shows a top plan view of transport conveyor 26, printed circuit board 10, illuminator 9 and camera array 4. Printed circuit board 10 is transported by conveyor 26 in a nonstop manner in the positive X direction, although embodiments of the present invention may also be practiced by programming the inspection system to operate with the printed circuit board being transported in the negative X direction. Printed circuit board 10 preferably travels at a velocity that varies less than five percent during the image acquisition process, although larger velocity variations and accelerations may be accommodated.

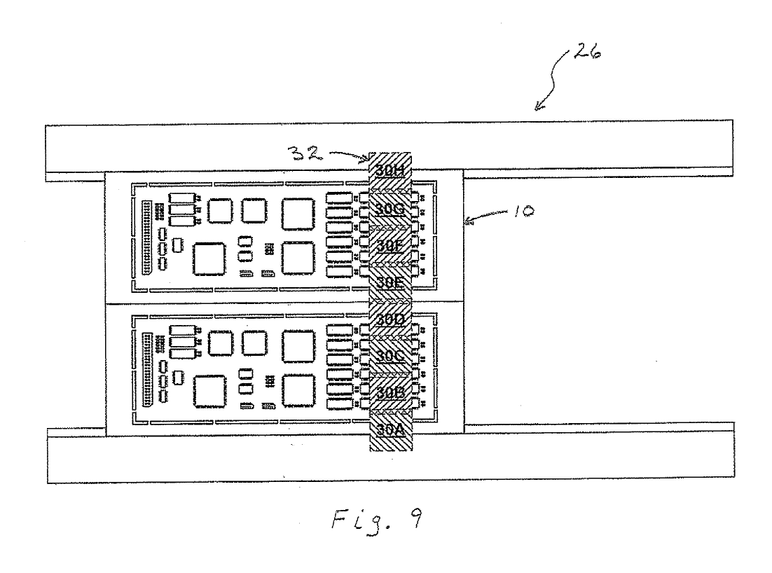

FIG. 9 shows an example image column 32 which is composed of overlapping field of views 32A-32H and is captured with a single type of illumination. For example, image column 32 may be collected by energizing strobed light sources 6C and 6D in order to produce brightfield illumination. In one preferred embodiment, each field of view 30A-30H has approximately 5 million pixels and an extent of 33 mm in the X direction and 44 mm in the Y direction. Each field of view 30A-30H overlaps neighboring fields of view by 4 mm in the Y direction so that center-to-center spacing for each camera 2A-2H is 40 mm in the Y direction.

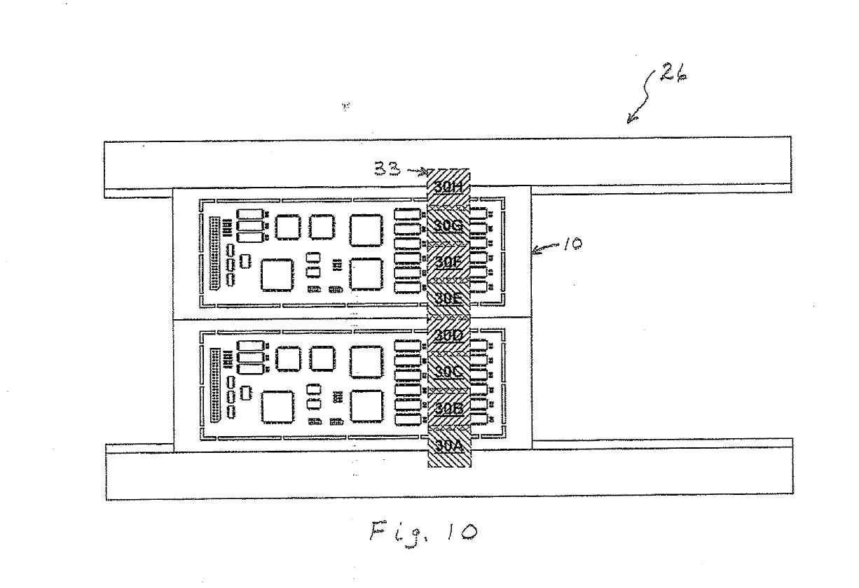

FIG. 10 shows printed circuit board 10 at a location displaced in the positive X direction from its location in FIG. 10. For example, printed circuit board 10 may be advanced approximately 14 mm from its location in FIG. 9. Image column 33 is composed of overlapping field of views 32A-32H and is captured under different illumination conditions than image column 32. For example, image column 33 may be collected by energizing strobed light sources 6A and 6A in order to produce darkfield illumination.

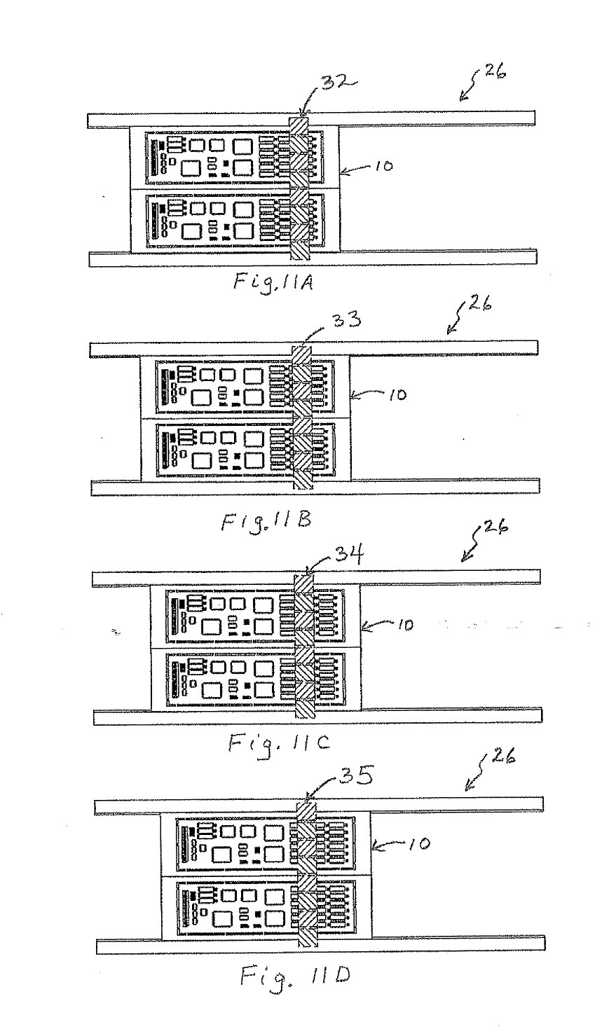

FIGS. 11A-11D show a time sequence of image columns collected under alternating illumination conditions. It is understood that printed circuit board 10 is traveling in the X direction in a nonstop fashion. FIG. 11A shows printed circuit board 10 at one X location during image acquisition for the entire printed circuit board 10. Image column 32 is collected using strobed brightfield illumination as discussed with respect to FIG. 9. FIG. 11B shows printed circuit board 10 displaced further in the X direction and image column 33 collected using strobed darkfield illumination as discussed with respect to FIG. 10. FIG. 11C shows printed circuit board 10 displaced further in the X direction and image column 34 collected using strobed brightfield illumination and FIG. 11D shows printed circuit board 10 displaced further in the X direction and image column 35 collected using strobed darkfield illumination.

There is a small overlap in the X dimension between brightfield illuminated image columns 32 and 34 in order to have enough overlapping image information in order to register and digitally merge, or stitch together, these column images. There is also small overlap in the X dimension between darkfield illuminated image columns 33 and 35 in order to have enough overlapping image information in order to register and digitally merge these column images. In the embodiment with fields of view 32A-32H having extents of 33 mm in the X direction, it has been found that an approximate 5 mm overlap in the X direction between image columns collected with the same illumination type is effective. Further, an approximate 14 mm displacement in the X direction between image columns collected with different illumination conditions is preferred.

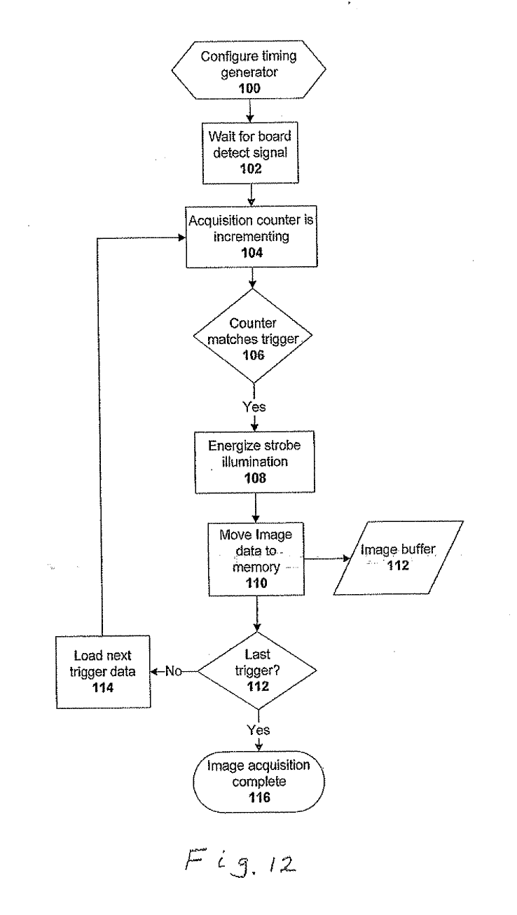

The image acquisition process will be further explained with respect to the flow diagram of FIG. 12 and the block diagram of FIG. 6. At step 100, timing generator 86 is configured with either time-based or encoder count trigger information. The trigger information includes the number of counts between when the leading edge of the board is detected and the first image acquisition. The trigger information also includes the count number for each image acquisition and its associated illumination pattern type. Step 102 waits for printed circuit board 10 to enter inspection system 92 and the leading edge of printed circuit board 10 to be detected by proximity sensor 24 and start the acquisition counter of timing generator 86. The acquisition counter of timing generator 86 is incremented at step 104 for each encoder or time pulse received. If the acquisition counter matches the next trigger count number, then camera array 4 begins an exposure and strobe lamp control 84 is commanded to energize the appropriate strobed light sources. For example, the illumination patterns may alternate between brightfield and darkfield patterns. The collected column image data is then transferred at high speed to buffer memory at step 110 in order to prepare cameras 2A-2H for the next image acquisition. Image buffer 112 may be the collection of individual image buffers 82A-82H or it may be one or more integrated memory storage areas. Step 112 tests whether the last trigger count has been attained. If not, then the next trigger count is loaded into the logic of timing generator 86 at step 114 and control returns to step 104. The image acquisition process is terminated at step 116 if the last trigger count has been reached at step 112.

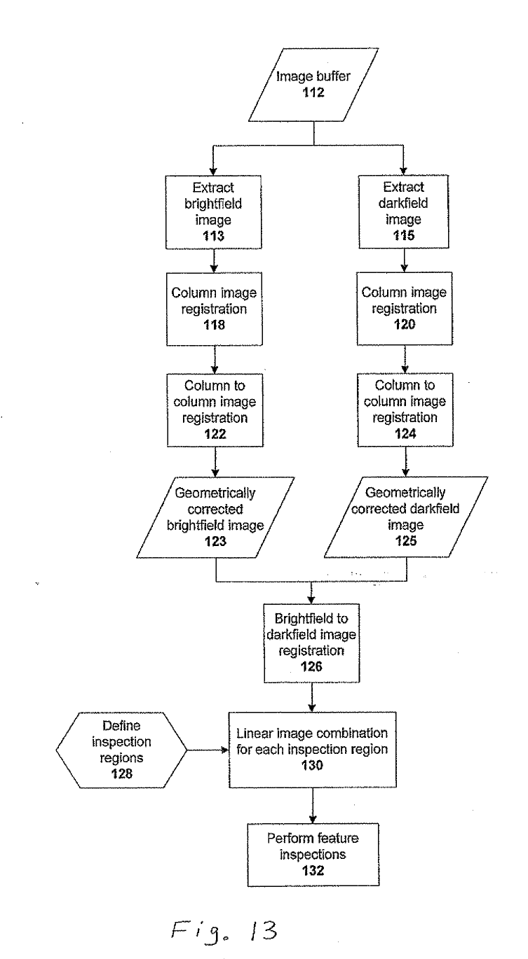

Image processing steps are further explained with reference to FIG. 13. For purposes of illustration it is assumed that two types of illumination, brightfield and darkfield, were used for the image acquisition process. Step 113 extracts the brightfield column images, such as those discussed with reference to FIG. 11, from image buffer 112. At step 118, a correlation operation is performed in the overlap regions between individual field of views 30A-30H to register the individual fields of view. The image data is merged, or stitched, into a single column image to eliminate the overlaps. This process of registering and merging is repeated for all sets of brightfield illuminated column images collected for printed circuit board 10. Each brightfield column image is then registered with respect to neighboring brightfield column images at step 122 using the column overlap information in the X direction. The output of step 122 is a geometrically corrected brightfield image 123 of printed circuit board 10 with one brightfield intensity value for each location on circuit board 10. The benefit to digitally registering and merging the image data is that expensive, precise motion control is not required. The velocity of printed circuit board 10 may vary slightly, there may be Y offsets between adjacent column images, and rotations in the θ_{z} direction between column images due to random motion of circuit board 10 may all be compensated by the image registration and merging process. The geometric correction process may also remove other image distortions and magnification changes. Process steps 113, 118, and 122 for brightfield images are repeated in steps 115, 120, and 124 for darkfield images. The result is a geometrically corrected image 125 of printed circuit board 10 with one darkfield intensity value for each location on printed circuit board 10. Brightfield image 123 and darkfield image 125 are correlated and registered at step 126. The result of step 126 is to associate both a brightfield and darkfield intensity value for each location on printed circuit board 10.

Process step 128 defines specific feature inspection regions. For example, region of interest 74 shown in FIG. 3B may be defined. Process step 128 also defines the coefficients to be used when combining the brightfield and darkfield images for each feature inspection. The coefficients are selected to maximize the image contrast required for each type of inspection. Feature inspection types might include solder fillet inspection, lead-to-pad registration, text recognition, correct part, and polarity. In FIG. 3B, region of interest 74 may be defined in order to inspect for the formation of a proper solder fillet, region of interest 72 may be defined in order to verify the text, and region of interest 70 may be defined in order to test for a polarity mark, for example. Process step 130 applies the appropriate coefficients to scale and sum the brightfield and darkfield intensity values for each location within each defined inspection region. Feature inspections are then performed in step 132 by using the linear combination of images generated in step 130 and the appropriate feature inspection algorithm. Alternatively, feature inspections may be performed by separately analyzing the brightfield and darkfield images and jointly processing those results.

Although the present invention, has been described with reference to preferred embodiments, workers skilled in the art will recognize that changes may be made in form and detail without departing from the spirit and scope of the invention. For example, while embodiments of the present invention are described with respect to a pair of strobed illumination field types, additional strobed illumination field types can also be used.

What is claimed is:

1. An optical inspection system for inspecting a workpiece including a feature to be inspected, the system comprising:
a workpiece transport conveyor configured to transport the workpiece in a nonstop manner; and
an illuminator configured to provide a first strobed illumination field type and a second strobed illumination field type;
an array of cameras configured to digitally image the feature, wherein the array of cameras is configured to generate a first image of the feature with the first illumination field and a second image of the feature with the second illumination field; and
a processing device operably coupled to the illuminator and the array of cameras, the processing device being configured to provide an inspection result relative to the feature on the workpiece based, at least in part, upon the first and second images.

2. The optical inspection system of claim 1, wherein an inspection region of interest, that includes the feature on the workpiece, is defined and stored in the processing device.

3. The optical inspection system of claim 2, wherein a first inspection is based on the first image, a second inspection is based on the second image, and the inspection result is based on the first and second inspections.

4. The optical inspection system of claim 2 wherein a third image of the inspection region is generated that is a linear combination from the region of interest in the first and second images.

5. The optical inspection system of claim 4, wherein the inspection result is based upon the third image.

6. The optical inspection system of claim 4, wherein the linear combination is a function that is defined relative to the region of interest.

7. The optical inspection system of claim 1, wherein the first illumination field is brightfield illumination.

8. The optical inspection system of claim 7, wherein the second illumination field is darkfield illumination.

9. The optical inspection system of claim 1, wherein the first illumination type is darkfield illumination.

10. The optical inspection system of claim 1, wherein each camera in the array of cameras is disposed to generate an image having a field of view that overlaps that of an adjacent camera.

11. The optical inspection system of claim 10, wherein the processing device is configured to cause the camera array to acquire columnar images that have fields of view that overlap with one another in a scan direction.

12. The optical inspection system of claim 11, wherein the first image is generated by stitching individual images from each camera, taken during energization of the first strobed illumination field type, together to form a columnar image, and stitching columnar images together.

13. The optical inspection system of claim 12, wherein the first image is geometrically corrected.

14. The optical inspection system of claim 12, wherein the second image is generated by stitching individual images from each camera, taken during energization of the second strobed illumination field type, together to form a columnar image, and stitching columnar images together.

15. The optical inspection system of claim 1, wherein the illuminator includes an illuminator enclosure that houses first and second illumination sources.

16. The optical inspection system of claim 15, wherein at least one of the first and second illumination sources is a xenon arc discharge lamp.

17. The optical inspection system of claim 15, wherein an interior surface of the illuminator enclosure has a highly reflective surface.

18. The optical inspection system of claim 17, wherein the highly reflective surface is configured to scatter light in multiple directions.

19. The optical inspection system of claim 15, wherein the illuminator enclosure includes an number of apertures, and respective cameras of the camera array are disposed to look through respective apertures of the illuminator enclosure.

20. The optical inspection system of claim 1, wherein the processing device stores data indicative of a plurality of regions of interest on the workpiece, and data indicative of a respective combination of first and second images for each region of interest, wherein at least two of the respective combinations differ from one another.

21. The optical inspection system of claim 1, wherein the illuminator is configured to provide an additional strobed illumination field type, and wherein the array of cameras is configured to acquire a third image of the feature with the additional illumination field.

22. A method of inspecting an article of manufacture having at least one region of interest to provide an inspection result, the method comprising:
generating relative motion between the article of manufacture and a camera array;
acquiring a first set of images with the camera array during the relative motion and while strobing a first illumination field type upon the article of manufacture;
acquiring a second set of images with the camera array during the relative motion and while strobing a second illumination field type upon the article of manufacture;
generating a first stitched image with the first set of images;
generating a second stitched image with the second set of images;
determining an inspection result relative to the at least one region of interest based upon the first and second stitched images; and
providing the inspection result.

23. The method of claim 22, wherein information defining each of the at least one region of interest is stored in a processing device.

24. The method of claim 23, and further comprising generating a third image of at least one region of interest as a linear combination in the first and second stitched images.

25. The method of claim 24, wherein the inspection result is based upon the third image.

26. The method of claim 24, wherein the linear combination is a function that is defined relative to the region of interest.

27. The method of claim 22, wherein the method begins automatically upon reception of a board detect signal.

28. The method of claim 22, wherein acquiring the first and second sets of images is triggered based upon a position encoder signal.

29. The method of claim 22, wherein acquiring the first and second sets of images is triggered based upon time.

30. An optical inspection system for inspecting a workpiece including a feature to be inspected, the system comprising:
a workpiece transport conveyor configured to transport the workpiece in a nonstop manner; and
an illuminator configured to provide a first strobed illumination having a first angular spectrum with respect to the feature and a second strobed illumination having a second angular spectrum with respect to the feature, wherein the first and second angular spectrums differ from one another;
an array of cameras configured to digitally image the feature, wherein the array of cameras is configured to generate a first image of the feature using the first strobed illumination and a second image of the feature using the second strobed illumination; and
a processing device operably coupled to the illuminator and the array of cameras, the processing device being configured to provide an inspection result relative to the feature on the workpiece based, at least in part, upon the first and second images.

31. The optical inspection system of claim 30, wherein the first strobed illumination has a first color, and the second strobed illumination has a second color, and wherein the first and second colors differ from one another.

32. The optical inspection system of claim 30, wherein one of the first and second strobed illuminations is a backlight strobed illumination.

33. The optical inspection system of claim 30, and further comprising a buffer memory operably coupled to the array of cameras to store the first and second images.
